(19) United States
(12) Patent Application Publication
(10) Pub. No.: US 2006/0259333 A1
(43) Pub. Date: Nov. 16, 2006

(54) Predictive exposure modeling system and method

(75) Inventors: Philip J. Pyburn, Weston, FL (US); James Ettwein, Acton, MA (US); William Snyder, Omaha, NE (US)

Correspondence Address: AKERMAN SENTERFITT, P.O. BOX 3188, WEST PALM BEACH, FL, 33402-3188, US

(73) Assignee: Inventum Corporation, Fort Lauderdale, FL (US)

(21) Appl. No.: 11/129,791

(22) Filed: May 16, 2005

(51) Int. Cl. G06Q 40/00

(52) U.S. Cl. 705/4

(57) ABSTRACT

An audit selection method (10) for commercial casualty policies (such as workers' compensation, employer's liability, and general liability policies) can include the steps of determining (14) a probability of under-reported exposure for a given policy (12) using classification modeling, identifying (24) a source of under-reported exposure using classification modeling, and selecting an audit protocol (28, 30, 32) effective or most effective in uncovering an under-reported exposure based on the probability determined and the source of under-reported exposure identified. Identifying the source of under-reported exposure can be done by identifying at least one among payroll increases, uninsured subcontractors, and misclassified occupations as examples. Determining the probability can be done by classifying the given policy according to a likelihood that an actual exposure for the given policy exceeds an exposure upon which an estimated premium was based requiring an additional premium for the given policy.

### FIELD OF THE INVENTION

This invention relates generally to insurance policy auditing, and more particularly to application of structured decision analysis, forecasting and classification modeling to identify auditable commercial casualty policies and to determine an optimal premium audit protocol to identify and document under-reported exposure resulting in an increase in additional premium produced by an insurance carrier's premium audit program.

### BACKGROUND OF THE INVENTION

Workers' Compensation (WC) insurance provides coverage for medical care, lost wages, death benefits and rehabilitation costs for employees with job-related injuries or diseases as a matter of right (without regard to fault). WC insurance is usually purchased by an employer from an insurance company, although in a few U.S. states there are monopolistic state funds through which WC insurance must be purchased. The premium for WC insurance is based on the employer's payroll and varies according to the risk-category of the employee's occupation.

Employer's Liability (EL) insurance provides coverage similar to WC for situations where the employee is not subject to benefits as a matter of right, but could sue for damages for injuries suffered under common law liability. The premium for EL insurance is based on the employer's payroll and varies according to the risk-category of the employee's occupation.

General Liability (GL) insurance provides coverage for an insured when negligent acts and/or omissions result in bodily injury and/or property damage on the premises of a business, when someone is injured as the result of using the product manufactured or distributed by a business, or when someone is injured in the general operation of a business. The premium for GL insurance can be based on several factors, including the insured's payroll, gross receipts, building size and attendees.

The initial premium paid by an insured for WC or EL coverage is based on the occupations of the insured's employees and the estimated payroll (including payments made to subcontractors) in each category of occupations. The occupational categories for WC coverage in the U.S. have been codified by the National Council on Compensation Insurance (NCCI) and/or state rating bureaus. All insurance carriers utilize either the NCCI codes or a respective state bureau code structure.

For example, prior to the inception of a policy a company might estimate:

| | | Annual | Rate/$100 | |
|---|---|---|---|---|
| Class | Description | Payroll | Payroll | Premium |
| 5437 | Carpentry - Cabinet Work | $200,000 | $9.11 | $18,220 |
| 5445 | Wallboard Installation | $125,000 | $9.38 | $11,725 |
| 8810 | Clerical | $78,000 | $0.36 | $281 |
| | | | TOTAL | $30,226 |

The initial premium calculation for GL coverage is similar to the example above, except that there are not multiple rate classes that apply to an insured. In the example above, the company might be classified as an Artisan Contractor, with a rate of $20.00 per $1000 of payroll.

In other words, the initial premium for an auditable policy is based on a priori estimates of the insured's payroll and classifications, not the actual payroll and classifications, which can only be determined after the policy expires. As a result, insurance carriers must perform an a posteriori audit of the insured's payroll and classification to ascertain what actually occurred. The policy contract language for auditable policies requires that an insured cooperate with an audit if the insurance carrier requests it, but the insurance regulations in most jurisdictions do not require that the carriers conduct an audit. In some jurisdictions, however, certain policies must be audited by regulation, as, for example, in Florida, where all WC policies with over $4,500 of estimated premium and all policies with construction classes must be physically audited annually. Payroll in construction classes is known to vary seasonally, and there is often widespread use of uninsured subcontractors and misclassification of employees.

In current commercial practice, premium audits are conducted by insurance carriers to identify under-reported exposure and the additional premium that is owed to the insurance carrier as a consequence of that under-reported exposure. In current practice, three premium audit protocols are used by the industry:
Physical audits—where an employee or representative of the carrier visits the insured's business location to review payroll records, discusses the insured's business with an authorized person and makes general observations about the business and its operation. For example, a field auditor might count the number trucks parked at the insured's facility to determine whether all of the truck drivers have been reported on the company's payroll records.
Telephone audits—where an employee or representative of the carrier telephones the insured to discuss payroll records, sometimes requesting that payroll tax filings and related documents be forwarded to the carrier.
Mail audits—where an employee or representative of the carrier sends the insured a letter requesting that payroll tax filings and related documents be forwarded to the carrier.

Insurance carriers determine which policies to audit in one of three typical ways: (1) The carrier performs a premium audit on all, or nearly all, policies, or; (2) the carrier performs a premium audit on a random selection of policies; or (3) the carrier performs a premium audit only on policies that exceed a certain level of estimated premium

Physical audits are usually performed for all policies that exceed a certain level of estimated premium. Telephone and mail audits are performed for smaller policies. No formal analysis is performed to determine if individual policies are more or less likely to under-report exposure.

From the perspective of identifying under-reported exposure (which is the objective of premium audits), these practices fail to differentiate between policies that are likely to have under-paid premium based on actual exposure and those that have not. As a result insurance carriers fail to maximize the potential net additional premium that the audit program identifies. In part, a less than optimum auditing result is a consequence of insufficient audit intensity on policies with significant under-reported exposure (for example, utilizing a mail audit protocol on a $2,500 policy that is likely to owe 50% additional premium when the under-reported exposure that is the source of this additional premium would only be uncovered by a physical audit). Also, these practices might result in premium audits being performed on policies that appear not to have under-reported exposure and that may require a premium refund (for example, utilizing a mail audit protocol that indicates a lower payroll than estimated, and a consequential premium refund, when a physical audit protocol would have uncovered subcontractor payments that actually result in a payroll increase, and consequently, additional premium).

### SUMMARY OF THE INVENTION

Embodiments in accordance with the present invention can provide a predictive exposure modeling method and decision system that can determine how premium audits should be conducted for auditable commercial casualty policies. Although the embodiments herein are not necessarily limited to workers' compensation and employer's liability policies, the methods and systems disclosed are particularly useful where a premium is based on the insured's payroll and related subcontractor payments. Auditable commercial casualty policies include workers' compensation, employer's liability and general liability coverage. The premium for such policies are typically estimated at the inception of the policy based on the insured's total payroll (including subcontractor payments) and the occupational class(es) of the insured's employees. Premium audits are performed by the insurance carrier (or their authorized agents) to determine the actual payroll and occupational classes so that the premium can be increased or decreased to reflect the actual exposure.

Embodiments in accordance with the present invention improve the financial results of premium audits by: (a) identifying policies where the premium paid is not adequate for the actual exposure (i.e. where there is under-reported exposure) and (b) determining the source of under-reported exposure (e.g., payroll increases, uninsured subcontractor payments, misclassification of occupations, etc.) by selecting the audit protocol that will be effective or most effective in uncovering such under-reported exposure. Embodiments herein can significantly increase the net additional premium produced by the premium audits as compared to traditional audit selection approaches. Net additional premium is the sum of the additional premium owed to the insurance carrier for policies where under-reported exposure is identified by premium audits less the sum of the return premium owed to insureds (where the premium audits identified less exposure than was originally estimated).

In a first embodiment of the present invention, an audit selection method for commercial casualty policies (such as workers' compensation, employer's liability, and general liability policies) can include the steps of determining a probability of under-reported exposure for a given policy using classification modeling, identifying a source of under-reported exposure using classification modeling, and selecting an audit protocol effective or most effective in uncovering an under-reported exposure based on the probability determined and the source of under-reported exposure identified. Identifying the source of under-reported exposure can be done by identifying at least one among payroll increases, uninsured subcontractors, and misclassified occupations as examples. Determining the probability can be done by classifying the given policy according to a likelihood that an actual exposure for the given policy exceeds an exposure upon which an estimated premium was based requiring an additional premium for the given policy. Determining the probability of under-reported exposure can use probabilistic structured decision analysis in the process of classifying. The actual exposure can be based on an employer's payroll, occupational classes assigned to an employer's employees, and other relevant criteria. The method can further include the step of auditing the given policy using an audit selected by the audit protocol selected among a physical audit, a telephonic audit, and a mail audit and further adjusting the premium of the given policy based on the results of the audit.

Note, the classification modeling can use a historical premium audit database containing insured data, policy data, agent data, historical premium audit results, claims data, industry data, and econometric data. The historical premium audit database can also compile additional records to the database as additional audits are performed. The method can also include the steps of pre-classifying the given policy if the given policy is among a policy subject to an interim audit or subject to a premium below a predetermined threshold or subject to an audit in prior years.

In a second embodiment of the present invention, a predictive exposure modeling system can include a first classification engine that determines a probability of under-reported exposure for a given policy using classification modeling, a second classification engine associated with the first classification engine that identifies a source of under-reported exposure using classification modeling and selects an audit protocol effective in uncovering an under-reported exposure based on the probability determined and the source of under-reported exposure identified, and a historical audit database coupled to the second classification engine, wherein the historical audit database contains data useful in identifying the source of under-reported exposure and selecting the audit protocol.

In a third embodiment of the present invention, a workers' compensation insurance policy classification method can include the steps of determining a likelihood that an actual exposure relating to at least one among payroll and occupational classes exceeds an exposure estimated for determining a premium for a given workers' compensation insurance policy using classification modeling, identifying a source of under-reported exposure using classification modeling that uses data from a historical audit database, and selecting an audit protocol effective in uncovering an under-reported exposure based on the likelihood determined and the source of under-reported exposure identified.

Other embodiments, when configured in accordance with the inventive arrangements disclosed herein, can include a system for performing and a machine readable storage for causing a machine to perform the various processes and methods disclosed herein.

### BRIEF DESCRIPTION OF THE DRAWINGS

FIG. 1 is a flow chart illustrating a predictive exposure modeling method in accordance with an embodiment of the present invention.

FIG. 2 is a flow chart illustrating a pre-classifying portion of a method in accordance with an embodiment of the present invention.

FIG. 3 is a flow chart illustrating another pre-classifying portion of the method in accordance with an embodiment of the present invention.

FIG. 4 is a flow chart illustrating yet another pre-classifying portion of the method in accordance with an embodiment of the present invention

FIG. 5 is a flow chart illustrating a portion of a method of audit selection using a probabilistic structured decision analysis in accordance with an embodiment of the present invention.

FIG. 6 is a flow chart illustrating a portion of a method in accordance with an embodiment of the present invention including steps for identifying a source of under-reported exposure.

FIG. 7 is a flow chart illustrating another portion of a method in accordance with an embodiment of the present invention including steps for identifying a source of under-reported exposure.

### DETAILED DESCRIPTION OF THE DRAWINGS

While the specification concludes with claims defining the features of embodiments of the invention that are regarded as novel, it is believed that the invention will be better understood from a consideration of the following description in conjunction with the figures, in which like reference numerals are carried forward.

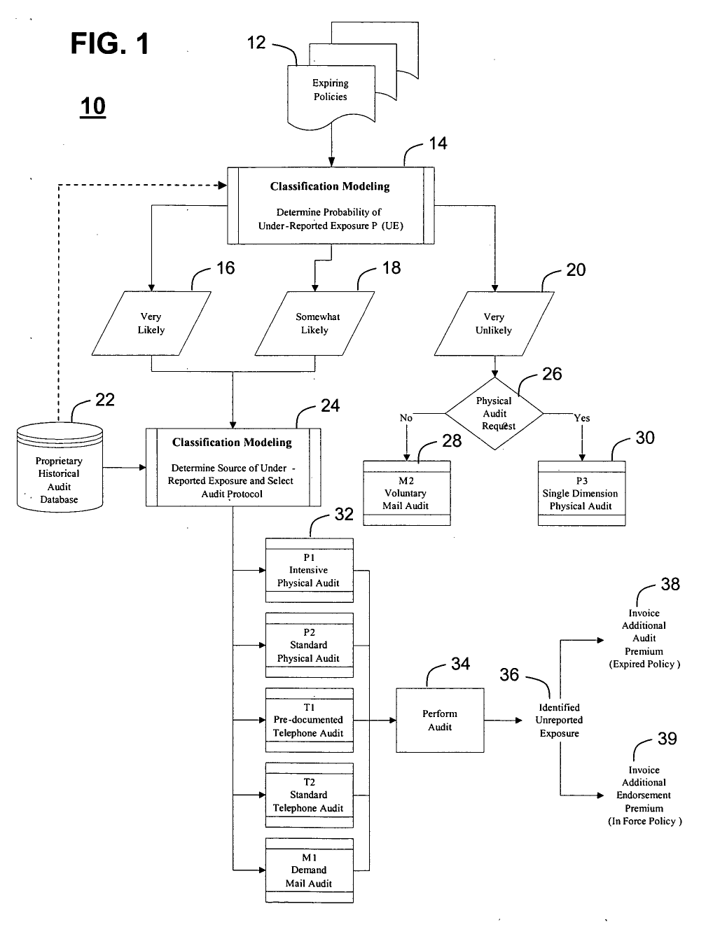

Referring to FIG. 1, a flow chart illustrating a method or business process 10 applies structured decision analysis, forecasting and classification modeling to identify auditable commercial casualty policies where the estimated premium paid was inadequate for the actual exposure incurred. Additionally, embodiments in accordance with the present invention apply structured decision analysis, forecasting and classification modeling to determine a suitable or (more likely) an optimal premium audit protocol to identify and document under-reported exposure resulting in an increase in the net additional premium produced by an insurance carrier's premium audit program. The method 10 begins analyzing or classifying at step 14 auditable policies 12 according to the likelihood that the actual exposure (i.e. payroll and occupational classes) exceeds the exposure upon which the estimated premium was based. In other words, Predictive Exposure Modeling is used to identify policies that are likely to owe additional premium. For example, such classification step 14 can initially classify policies as having a very likely probability (16), somewhat likely probability (18), or very unlikely probability (20) of under-reported exposure. The classification step 14 can use the historical audit database 22 to assist in the classification process. If the classification step 14 determines that the particular policy has an unlikely probability of being under-reported, then an inquiry is made at decision block 26 whether a physical audit was requested. If no physical audit was requested, then a simple voluntary mail audit (M2) is performed at step 28 and otherwise a simple physical audit (P3) can be performed at step 30.

If the policy is either classified as having a likely or somewhat likely probability of being under-reported, then the method 10 determines the sources of under-reported exposure (i.e. payroll increases, uninsured subcontractors, mis-classification) at step 24 and selects the premium audit protocol 32 (P1, P2, T1, T2, M1) that will be effective or most effective in uncovering the under-reported exposure. Once the audit protocol is selected, the audit is performed at step 34 and the unreported exposure is identified at step 36. At this point, the auditing agent for the insurance company or the insurance company themselves, can either invoice for additional audit premium (on an expired policy) at step 38, or invoice for additional endorsement premium (on an active or in-force policy) at step 39.

Embodiments in accordance with the present invention can utilize several widely available analytic and mathematical modeling techniques to facilitate the classification of policies and the selection of audit protocols, including documented heuristics (“rules of thumb”) that have been developed by the inventors. The details of the models, including techniques used, structure and parameters continue to evolve as additional data is gathered. In other words, the specific structure of the models that can be used or developed over time and the parameters of the models will change as further information is gathered. A number of techniques are currently available that can perform the classification, and there certainly are no limitations in what mathematicians can probably develop in the future. Regardless of the modeling technique used to perform the classification and selection, existing technology fails to generally address a system that performs a premium audit classification and an auditing protocol selection based on the classification as contemplated herein.

In practical terms, a company employing the techniques herein can review and evaluate each month all of the policies that expire in a subsequent month to determine the likelihood that an actual exposure (e.g., payroll and occupational classes in the case of workers' compensation) exceeds an estimated exposure when the policy was originally written. The models and techniques used to perform this evaluation can use the historical audit database 22. As noted above, such models and techniques can be continuously refined as additional audits are performed. The policies can be categorized according to the magnitude of under-reported exposure that is likely to exist and according to the source of that under-reported exposure (e.g. payroll increases, misclassification of occupations, under-reported subcontractor payments, etc.) Based upon this classification, each policy is assigned an audit protocol 32 that will be effective, or most effective, in identifying and documenting (36) the under-reported exposure and the consequent additional premium. The exposure basis of each policy is adjusted based on the premium audit results, and the final premium is calculated on the new exposure basis. The insured is invoiced for the additional premium (or sent a return premium payment if the audit reduced the exposure basis) for the expired policy, and if the insured has renewed coverage, that policy is also endorsed to reflect the revised exposure basis.

In current practice, insurance carriers utilize only a small fraction of the information that is available to them to determine whether to select a policy for a premium audit and how that audit should be conducted. Predictive Exposure Modeling as contemplated herein can utilize a wide array of available data, including: Insured Data including one or more among Industry Code (SIC Code), Headquarters Location (Mail Code), Operating Locations (Mail Code), Number of Employees by Occupational Class, Age of Employees by Occupational Class, Total Revenue, Historical Premium Audit Results, Prior Cancellation for Non-Payment of Audit Premium, Total Payroll, Payroll History, Ownership Structure (Proprietorship, Partnership, Corporation), Number of Years in Business, Previous Insurance Carrier, and Prior Year Premium; Policy Data including one or more among Governing (Main) Occupation Class Code, Secondary Occupation Class Codes, Estimated Premium, Experience Modifiers and Rating Elements (Discounts), and Policy Type (New vs. Renewal); Agent Data including one or more among, Location, Agency Type, and Agency Premium Audit History; Historical Premium Audit Results including one or more among Additional Payroll by Class, Payroll Attributable to Subcontractors, and Class Additions/Modifications; Claims Data, including one or more among Loss History, and Cause of Reported Injuries; and Econometric Data including one or more among Industry Growth in Operating Locations, Employment Growth in Operating Locations, and Industry Profitability. As premium audits are conducted, records are added to the Premium Audit Database 22, thereby enhancing the efficacy of Predictive Exposure Modeling.

The audit protocols 32, 28 and 30 include protocols labeled P1, P2, P3, T1, T2, M2, and M2 as further detailed below. Note that these audit protocols are just examples and that other alternative audit protocols can be used within the scope and spirit of the claims contemplated herein.

P1 Audit Protocol—The most intensive physical audit protocol where the field auditor is required to:
a. Review multiple documents to determine the accuracy of payroll and occupational class, including payroll records, payroll tax returns, unemployment tax returns, purchase invoices, income tax returns, commercial property insurance policies, etc.
b. Observe the business operation, including visits to multiple job sites as necessary, and discuss the business operation with multiple individuals
c. Evaluate the documents and observation notes to detect discrepancies that suggest under-reported payroll and mis-classification of occupations.

The P1 audit protocol is sometimes a response to a P2 audit that produces results that are significantly different from model prediction. The insured is required to cooperate with a P1 audit and failure to do so may result in policy cancellation or the imposition of significant additional premium (typically 100%-300% of the original estimated premium)

P2 Audit Protocol—A standard physical audit protocol where the field auditor is required to:
a. Review payroll records, payroll tax returns and unemployment tax returns
b. Observe the business operation and discuss the business operation with a single individual
c. Evaluate the documents and observation notes to detect discrepancies that suggest under-reported payroll and mis-classification of occupations

The insured is required to cooperate with a P2 audit and failure to do so will result in policy cancellation or the imposition of significant additional premium (typically 100%-300% of the original estimated premium)

P3 Audit Protocol—A limited physical audit protocol where the field auditor is required to review payroll records and payroll tax returns. In some jurisdictions, the insured is required to cooperate with a P3 audit and failure to do so may result in policy cancellation. In other jurisdictions, cooperation is not required.

T1 Audit Protocol—An intensive telephone audit protocol where the auditor is required to:
a. Obtain copies of payroll records, payroll tax returns and unemployment tax returns (typically via Fax).
b. Conduct a follow-up teleconference after the required documents have been received.
c. Evaluate the documents and teleconference notes to detect discrepancies that suggest under-reported payroll and mis-classification of occupations.

The insured is required to cooperate with a T1 audit and failure to do so may result in policy cancellation or the imposition of significant additional premium (typically 100%-300% of the original estimated premium)

T2 Audit Protocol—A standard telephone audit protocol where the auditor is required to discuss payroll and occupational classifications with the ensured. The insured is required to cooperate with a T2 audit and failure to do so may result in policy cancellation or the imposition of significant additional premium (typically 100%-300% of the original estimated premium).

M1 Audit Protocol—A demand-response mail audit protocol where the auditor is required to:
a. Obtain written copies of payroll records, payroll tax returns and unemployment tax returns
b. Evaluate the documents to detect discrepancies that suggest under-reported payroll and mis-classification of occupations.

The insured is required to cooperate with a M1 audit and failure to do so may result in policy cancellation or the imposition of significant additional premium (typically 100%-300% of the original estimated premium).

M2 Audit Protocol—A voluntary-response mail audit protocol where the auditor requests written copies of payroll records, payroll tax returns and unemployment tax returns. The insured is not required to cooperate with an M2 audit. If the requested documents are not submitted, the original estimated premium is determined to be the final premium.

With respect to classification modeling as contemplated in embodiments of the invention herein, such embodiments can include: (a) the classification of each policy according to a likelihood of under-reported exposure (14) and (b) an identification of the source of under-reported exposure and the selection of the audit protocol that will be most effective in identifying that under-reported exposure (24). Those skilled in the art will recognize that a wide range of modeling techniques and analytic procedures have been developed to address such classification problems and otherwise accomplish the classification task.

While not definitive, the following modeling techniques can usefully be applied:
1) Structured Decision Models
   a) Rule-Based Expert System Model
   b) Neural Network Model
2) Probabilistic Models
   a) Statistical Model
   b) Bayesian Belief Network Model
3) Classification Models
   a) Decision Tree Classifier
   b) Linear Classifier Model
   c) Quadratic Classifier Model
   d) Piecewise Classifier Model
   e) k-Nearest Neighbor Model
4) Learning Machine Models.

Those skilled in the art will also recognize such models often utilize a range of algorithms, mathematical techniques and data analysis routines to facilitate the model development and computation within the models themselves. Again, while not definitive, the following algorithms and techniques are applicable:
1) Convex Quadratic Optimization Techniques
2) Support Vector Machine (SVM) Algorithms
   a) Mercer's Kernal
3) Statistical Learning Algorithms
4) Parameter Estimation Techniques
   a) Statistical Estimation
   b) Maximum-Likelihood Estimation
   c) Bayesian Estimation
   d) Bootstrap Estimation
5) Feature Extraction and Mapping techniques
   a) Redundancy Reduction—Data Reduction, Dimensionality Reduction
   b) Linear Component Analysis
   c) Linear Discriminant Analysis
   d) Nonlinear Discriminant Analysis—Kernel Methods

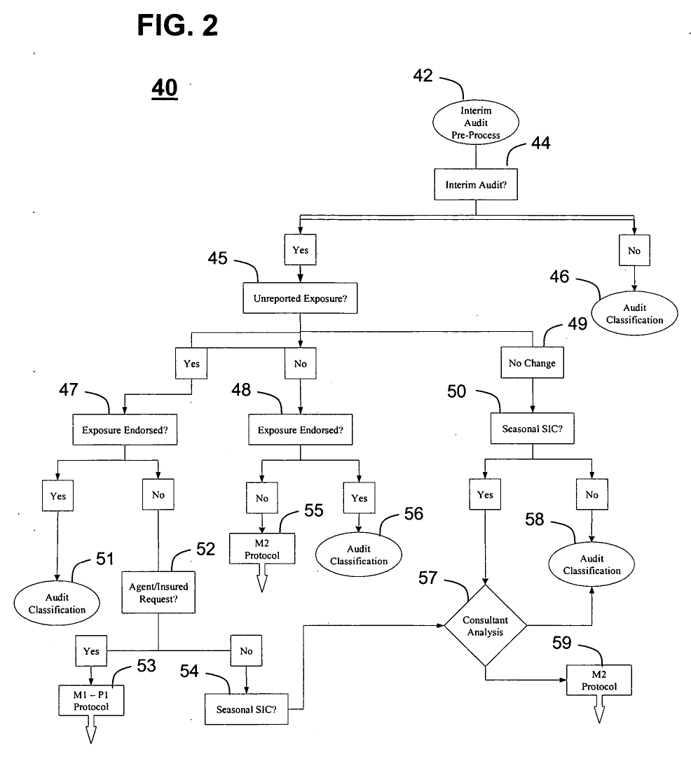

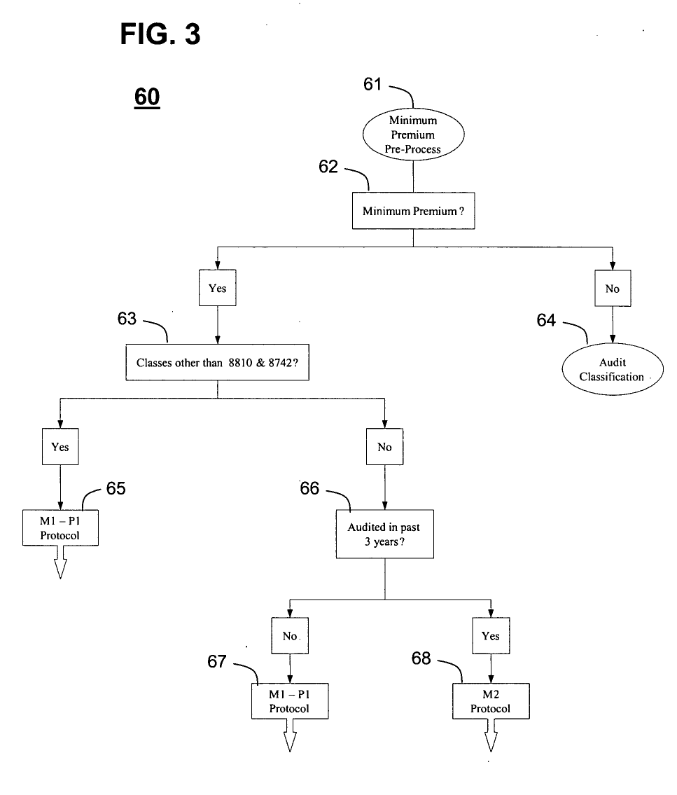

In one particular implementation as illustrated in FIGS. 2-7, a series of Probabilistic Structured Decision Analysis models were used to produced a desired set of classifications. In a first step as illustrated in the alternative embodiments of FIGS. 2-3, the classification analysis and Predictive Exposure Modeling can be simplified by recognizing two special cases that can be used to pre-classify some policies as requiring either the M2/P3 audit protocols or one of the M1-P1 protocols.

In the special case of process 40 as illustrated in FIG. 2, if an interim audit 42 occurs, then an inquiry at step 44 can be made. If no interim audit exists, then the audit classification continues at step 46. If an interim audit does exist, then a determination is made whether there is an unreported exposure at step 45. If an unreported exposure exists, a determination is made whether the exposure is endorsed at step 47. If such exposure is endorsed, then the audit classification continues at step 51 similar to step 46. If no endorsement exists at step 47, then a determination is made whether an insurance agent or the insured made a specific request. If a request is made at step 52, then the more stringent M1-P1 audit protocols are recommended at step 53. If no request exists at step 52, then an inquiry regarding a seasonal SIC or employee classification is made at step 54 and a subsequent consultant analysis at decision block 57 determines whether such policy should be audited under the M2 audit protocol at step 59 or the routine audit classification should continue at step 58 similar to steps 46, and 51. If no unreported exposure exists at step 45 and no exposure is endorsed at step 48, then the M2 audit protocol is used at step 55. If no unreported exposure exists at step 45, but the exposure is nonetheless endorsed at step 48, then the audit classification continues at step 56 similar to steps 46, 51, and 58. If no change is found at step 49 with respect to the unreported exposure, a further inquiry is made whether the SIC or employee classification for the particular policy is a seasonal SIC at step 50. If seasonal, then the consultant analysis 57 determines the audit classification path. If the SIC is not seasonal, then the process 40 proceeds to step 58 to continue the audit classification similar to steps 46, 51, and 56.

In another special case as illustrated in the process 60 of FIG. 3, a minimum or threshold amount of premium is determined from steps 61 and 62. If the policy does not meet the minimum premium or a threshold premium amount, then the audit classification process continues at step 64. If the minimum or threshold is exceeded, a further determination for employee classes other than those having lower exposure such as clerical (SIC Code 8810) is made at step 63. If the higher exposure employee classes are involved, then the more stringent M1-P1 audit protocols are used. If the lower exposure employee classes are involved a further determination as to past audits within the last three years is made at step 66. If no recent audits are indicated, then the more stringent audit protocol is recommended again at step 67. If a recent audit (within the last three years, for example) is indicated, then a less stringent audit (M2) is recommended at step 68.

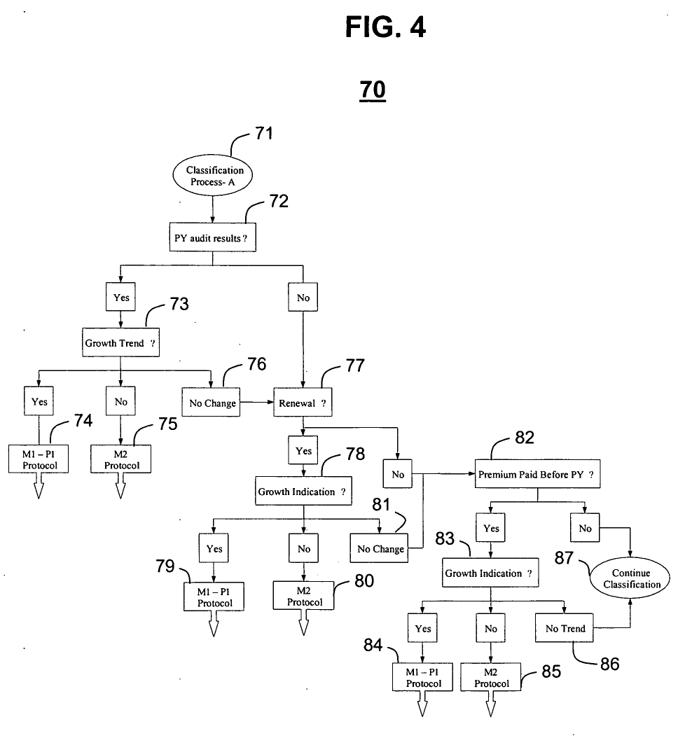

At a next step in the classification modeling, further refinements can be initially made to determine the probability of under-reported exposure by incorporating the results of premium audits performed in prior years, as illustrated in the process 70 of FIG. 4. and starting at step 71. If prior year audits are indicated at step 72, then a further inquiry as to a growth trend is made at step 73. If a growth trend is indicated, then a more stringent audit protocol is recommended at step 74. If no growth trend is indicated, then a less stringent audit protocol is recommended at step 75. If no changes in growth are indicated at step 76 or if there are no prior year audit results, then a further inquiry is made as to whether the policy is up for renewal at step 77. If a renewal is indicated, once again a further inquiry is made as to a growth indication at step 78 with a more stringent audit protocol recommended for positive growth at step 79 and a less stringent audit protocol recommended for no growth at step 80. If no change is indicated in growth at step 81 or if no renewal is indicated, a further inquiry is made as to whether the premium was paid before the prior year. Once again, if premium payment before a prior year is indicated at step 82, then a further inquiry as to a growth trend is made at step 83. If a growth trend is indicated, then a more stringent audit protocol is recommended at step 84. If a negative growth trend is indicated, then a less stringent audit protocol is recommended at step 85. If either a no growth trend (flat) indication is given at step 86 or no premium was paid before the prior year, then the classification process continues at step 87.

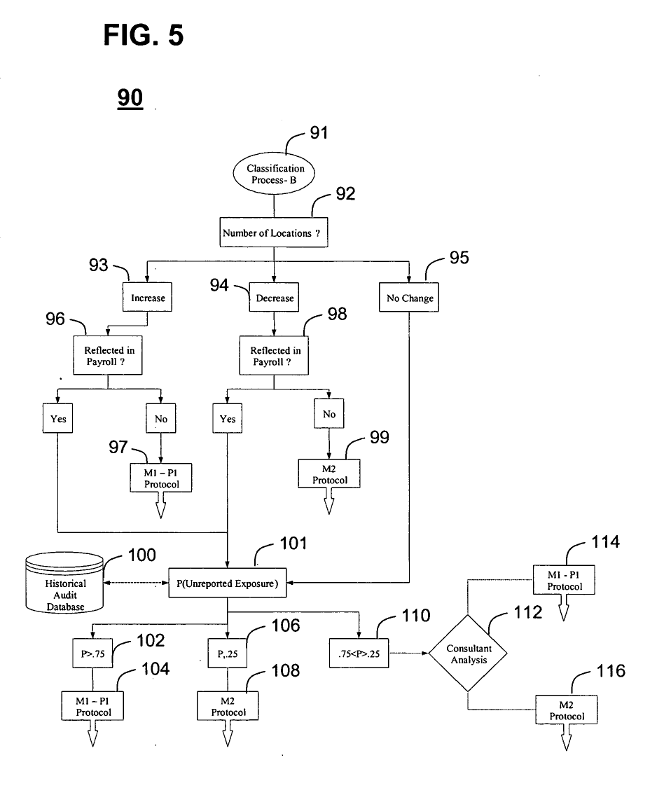

The classification modeling to determine the probability of under-reported exposure is conducted utilizing Probabilistic Structured Decision Analysis as illustrated by the process 90 of FIG. 5. The process begins at step 91 and continues with a determination of a number of locations for a particular policy at step 92. If an increase is indicated at step 93, then a further inquiry is made to see whether such increase in locations is reflected in the payroll at step 96. If the payroll is not reflective of the increase in locations, then a more stringent audit is recommended at step 97. Otherwise, the probability of unreported exposure for the particular policy is estimated at step 101 using data from historical database 100. If a high probability exists (P>0.75) of an unreported exposure at step 102, then a more stringent audit protocol is recommended at step 104. If a lower probability exists at step 106, then a less stringent audit protocol is recommended at step 108. If a somewhat high probability (0.75<P>0.25) exists of an unreported exposure at step 110, then further analysis can be done by a consultant at decision block 112 where either more stringent audit protocol at step 114 or a less stringent audit protocol at step 116 can be recommended.

If a decrease is indicated at step 94, then a further inquiry is made to see whether such decrease in locations is reflected in the payroll at step 98. If the payroll is not reflective of the decrease in locations, then a less stringent audit is recommended at step 99. Otherwise, the probability of unreported exposure for the particular policy is once again estimated at step 101 using data from historical database 100 and the process continues as previously described. Also note, if no change is indicated in the number of locations at step 95, the process 90 once again proceeds to determine the probability of unreported exposure at step 101.

Note the probability for under-reported exposure can be denoted as follows:
P(Under-reported Exposure)=f(α+b₁X₁+b₂X₂+b₃X₃+ . . . b₇X₇)
Where:
X₁=Governing Class Code Group
X₂=Metropolitan Statistical Area Group
X₃=Largest Secondary Class Code Group
X₄=Years in Business
X₅=Estimated Premium
X₆=Claims Experience
X₇=Corporate Ownership Structure
(The actual variables used and evaluated in the above and following examples can and will vary (more, fewer, or different) depending on the conditions of the carrier, or the information that is known about the policy data.)

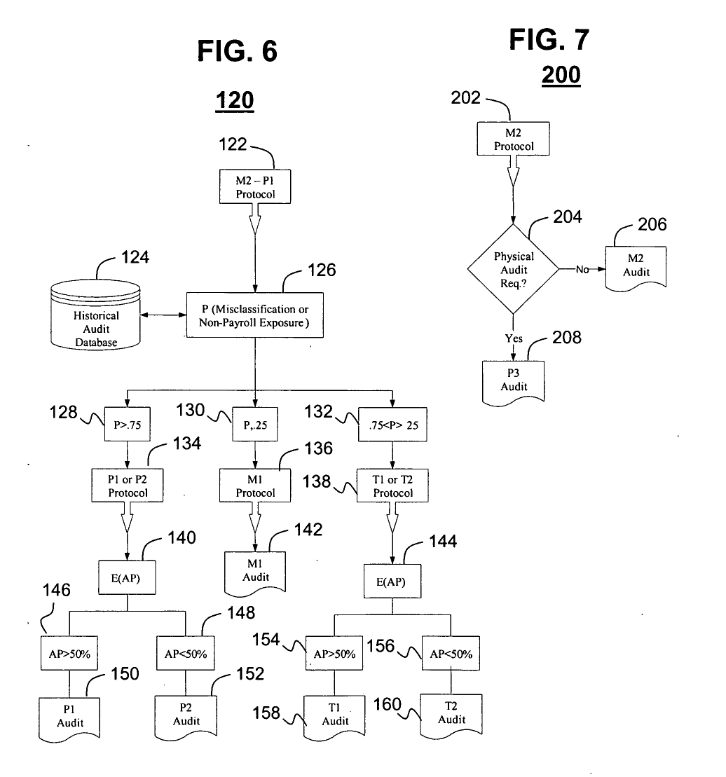

In a final step in a Predictive Exposure Modeling process an identification of the source of under-reported exposure (i.e. payroll increases, uninsured subcontractors, mis-classification, etc.) and the selection of audit protocol is performed as illustrated in FIGS. 6 and 7. Further note that the probability for misclassification or non-payroll exposure can be denoted at follows:
P(Misclassification or Non-Payroll Exposure)=f(α+b₁X₁+b₂X₂+b₃X₃+ . . . b₅X₅)
Where:
X₁=Governing Class Code Group
X₂=SIC Group
X₃=Number of Class Codes
X₄=Estimated Premium
X₅=MSA Labor Market Growth Factor
E(AP)=f(α+b₁X₁+b₂X₂+b₃X₃+b₄X₄)
Where:
X₁=Total Payroll
X₂=Estimated Premium
X₃=Governing Class Code Group
X₄=Agent History

Referring once again to FIG. 6, a process 120 can identify the source of under-reported exposure and select the appropriate audit (procedures) to uncover the under-reported exposure. Using a historical audit database 124 along with any data from prior audit protocols 122 for the particular policy involved, a probability of misclassification or non-payroll exposure can be done at step 126. If the probability is high of non-reporting at step 128, then a more stringent protocol (such as a physical audit P1 or P2) is recommended. A further assessment of whether additional premium is done at step 140. If more than a 50% chance that additional premium is indicated at step 146, then a more stringent P1 audit can be done at step 150. Alternatively, if a less than 50% chance that additional premium is indicated at step 148, then a slightly less stringent P2 audit is performed at step 152. If the probability is relatively low of non-reporting at step 130, then a less stringent protocol (such as a mail audit M1) is recommended at step 136 and a mail audit can then follow at step 142 accordingly.

If the probability is somewhat high of non-reporting at step 132 (but not as high as in step 128), then a stringent telephone audit protocol (such as a T1 or T2 Audit) is recommended. A further assessment of whether additional premium is done at step 144. If more than a 50% chance that additional premium is indicated at step 154, then the more stringent T1 audit can be done at step 158. Alternatively, if a less than 50% chance that additional premium is indicated at step 156, then a slightly less stringent T2 audit is performed at step 160.

Referring to the process 200 of FIG. 7, if a less stringent audit protocol such as the M2 mail audit protocol is recommended at step 202, then a further inquiry can be made at step 204 to determine whether a physical audit was requested (by the insured or agent). If no physical audit was requested, then the less stringent mail audit is performed at step 206. If a physical audit is requested, then the least stringent physical audit (P3) is performed at step 208.

In light of the foregoing description, it should be recognized that embodiments in accordance with the present invention can be realized in hardware, software, or a combination of hardware and software. A network or system according to the present invention can be realized in a centralized fashion in one computer system or processor, or in a distributed fashion where different elements are spread across several interconnected computer systems or processors (such as a microprocessor and a DSP). Any kind of computer system, or other apparatus adapted for carrying out the functions described herein, is suited. A typical combination of hardware and software could be a general purpose computer system with a computer program that, when being loaded and executed, controls the computer system such that it carries out the functions described herein.

In light of the foregoing description, it should also be recognized that embodiments in accordance with the present invention can be realized in numerous configurations contemplated to be within the scope and spirit of the claims. Additionally, the description above is intended by way of example only and is not intended to limit the present invention in any way, except as set forth in the following claims.

What is claimed is:

1. An audit selection method for commercial casualty policies, comprising the steps of:
determining a probability of under-reported exposure for a given policy using classification modeling;
identifying a source of under-reported exposure using classification modeling; and
selecting an audit protocol effective in uncovering an under-reported exposure based on the probability determined and the source of under-reported exposure identified.

2. The audit selection method of claim 1, wherein the step of determining the probability of under-reported exposure using classification modeling comprises the step of classifying the given policy according to a likelihood that an actual exposure for the given policy exceeds an exposure upon which an estimated premium was based requiring an additional premium for the given policy.

3. The audit selection method of claim 2, wherein the commercial casualty policies are worker's compensation policies and the actual exposure is based on at least one among an employer's payroll and occupational classes assigned to an employer's employees.

4. The audit selection method of claim 1, wherein the step of selecting the audit protocol is done by selecting the audit protocol most effective in uncovering the under-reported exposure.

5. The audit selection method of claim 1, wherein the method further comprises the step of auditing the given policy using an audit selected by the audit protocol selected among a physical audit, a telephonic audit, and a mail audit.

6. The audit selection method of claim 5, wherein the method further comprises the step of adjusting the premium of the given policy based on the results of the audit.

7. The audit selection method of claim 1, wherein the classification modeling uses a historical premium audit database containing insured data, policy data, agent data, historical premium audit results, claims data, and econometric data.

8. The audit selection method of claim 7, wherein the classification modeling uses a historical premium audit database containing insured data selected among industry codes, location codes, number of employees by occupational class, age of employees by occupational class, total revenue, historical premium audit results, prior cancellation for non-payment of audit premium, total payroll, ownership structure, number of years in business, previous insurance carrier, and prior year premium; policy data selected among main occupation class code, secondary occupation class code, estimated premium, experience modifiers, rating elements, policy type; agent data selected among location, agency type, and agency premium audit history; historical premium audit results selected among additional payroll by class, payroll attributable to subcontractors, and class additions/modifications; claims data selected among loss history and cause of reported injuries; and econometric data selected among industry growth in operation locations, employment growth in operation locations, and industry profitability.

9. The audit selection method of claim 1, wherein the classification modeling uses a historical premium audit database that compiles additional records to the database as additional audits are performed.

10. The audit selection method of claim 1, wherein the method further comprises the step of pre-classifying the given policy if the given policy is among a policy subject to an interim audit or subject to a premium below a predetermined threshold.

11. The audit selection method of claim 1, wherein the method further comprises the step of pre-classifying the given policy if the given policy was subject to an audit in prior years.

12. The audit selection method of claim 1, wherein the step of determining the probability of under-reported exposure using classification modeling comprises the step of using probabilistic structured decision analysis.

13. The audit selection method of claim 1, wherein the step of identifying the source of under-reported exposure comprises identifying at least one among payroll increases, uninsured subcontractors, and misclassified occupations.

14. A predictive exposure modeling system, comprising:
a first classification engine that determines a probability of under-reported exposure for a given policy using classification modeling;
a second classification engine associated with the first classification engine that identifies a source of under-reported exposure using classification modeling and selects an audit protocol effective in uncovering an under-reported exposure based on the probability determined and the source of under-reported exposure identified; and
a historical audit database coupled to the second classification engine, wherein the historical audit database contains data useful in identifying the source of under-reported exposure and selecting the audit protocol.

15. The predictive exposure modeling system of claim 14, wherein the historical premium audit database contains insured data, policy data, agent data, historical premium audit results, claims data, and econometric data.

16. The predictive exposure modeling system of claim 14, wherein the system further comprises a pre-classifier that uses data selected among an interim audit for the given policy, threshold premium data amounts, and audit data from prior years for the given policy.

17. A machine-readable storage, having stored thereon a computer program having a plurality of code sections executable by a machine for causing the machine to perform the steps of:
determining a probability of under-reported exposure for a given policy using classification modeling;
identifying a source of under-reported exposure using classification modeling; and
selecting an audit protocol effective in uncovering an under-reported exposure based on the probability determined and the source of under-reported exposure identified.

18. The machine readable storage of claim 17, wherein the machine readable storage further comprises another plurality of code sections executable by the machine for causing the machine to classify the given policy according to a likelihood that an actual exposure for the given policy exceeds an exposure upon which an estimated premium was based requiring an additional premium for the given policy.

19. The machine readable storage of claim 17, wherein the machine readable storage further comprises another plurality of code sections executable by the machine for causing the machine to pre-classify the given policy if the given policy is among a policy subject to an interim audit or subject to a premium below a predetermined threshold or Subject to an audit in prior years.

20. A workers' compensation insurance policy classification method, comprising the steps of:
determining a likelihood that an actual exposure relating to at least one among payroll and occupational classes exceeds an exposure estimated for determining a premium for a given worker's compensation insurance policy using classification modeling;
identifying a source of under-reported exposure using classification modeling that uses data from a historical audit database; and
selecting an audit protocol effective in uncovering an under-reported exposure based on the likelihood determined and the source of under-reported exposure identified.
